(19) United States
(12) Patent Application Publication
(10) Pub. No.: US 2005/0107152 A1
(43) Pub. Date: May 19, 2005

(54) Stored value lottery card and methods

(75) Inventors: Chris McGee, Parker, CO (US); Steven Arthur, Parker, CO (US); Jaime Paul Brown, Denver, CO (US); Ken Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/922,815

(22) Filed: Aug. 19, 2004

Related U.S. Application Data
(63) Continuation-in-part of application No. 10/744,888, filed on Dec. 23, 2003.
(60) Provisional application No. 60/520,486, filed on Nov. 14, 2003.

(51) Int. Cl. G06F 17/00

(52) U.S. Cl. 463/17

(57) ABSTRACT

In one embodiment, a method for authorizing lottery transactions comprises receiving an account identifier for a stored value lottery account from a lottery system. The account identifier is authenticated at a host computer system and an authentication is transmitted to the lottery system. A cost associated with one or more lottery picks for a lottery transaction is received from the lottery system, a determination is made at the host computer system that the cost does not exceed an account balance associated with the account identifier, and an authorization for the lottery transaction is transmitted to the lottery system.

### CROSS-REFERENCES TO RELATED APPLICATIONS

This application is a continuation-in-part of U.S. application Ser. No. 10/744,888, filed Dec. 23, 2003, which is a non-provisional application claiming the benefits of U.S. Provisional Application No. 60/520,486, filed Nov. 14, 2003, the complete disclosures are both herein incorporated by reference.

This application is also related to U.S. Provisional Patent Application Ser. No. 60/520,488 filed Nov. 14, 2003, entitled “System for Accounting”; U.S. Provisional Patent Application Ser. No. 60/520,432 filed Nov. 14, 2003, entitled “Bulk Card Ordering System and Methods”; U.S. patent application Ser. No. 10/714,437 filed Nov. 14, 2003, entitled “Open Loop Stored Value System”; U.S. patent application Ser. No. 10/744,441 filed Nov. 14, 2003, entitled “Open Loop Stored Value Account Configuration”, which are incorporated by reference in their entirety.

### BACKGROUND OF THE INVENTION

This invention relates generally to the field of lotteries, and in particular to ways to play various types of lotteries. In one specific example, the invention relates to systems and techniques to pay for and to participate in a lottery.

Various states have enacted statutes establishing lotteries. Once such example is the state of Colorado. As explained on their official web site (www.coloradolottery.com), lottery products are sold at retail locations. In return for selling the lottery products, the retailers get various commissions and bonuses. In the state of Colorado, such lottery products include Scratch, Lotto, Cash 5 and Powerball. These games are played by purchasing a ticket at the retail location using a point of sale device. To get a ticket, the player must make a cash payment (which includes payments using a debit card, check, or the like) to the clerk who then issues the ticket using the point of sale device. At the prescribed time, winning numbers are generated. The winning numbers may be displayed at the retail locations and certain payouts may also be redeemed at the retail locations.

Scratch games are played by purchasing a card with a latex covering. This covering is scratched off to see if the numbers or symbol match a winning number or symbol. If so, the winning ticket may be redeemed for a prize. Lotto is a jackpot game where players select six numbers from a field of 42 and prizes are awarded for matching 3, 4, 5, or 6 or the numbers. The numbers may be generated from the point of sale device using a “quick pick” selection as well. The amount of the prize depends on how many numbers match.

The Play Cash 5 game requires the player to select five numbers from a field of 32 possible numbers. If a player matches 2, 3, 4, or 5 numbers, they win a prize. With Powerball, players pick 5 out of 53 numbers and one Powerball number between 1 and 42. The lure of Powerball is that the jackpot starts and $10 million and the growth potential is large.

Other states offer similar lottery products. This invention relates to techniques and systems to facilitate these and other kinds of lottery systems.

### BRIEF SUMMARY OF THE INVENTION

In one embodiment, the invention provides a method for authorizing a lottery transaction. The method comprises receiving an account identifier for a stored value lottery account from a lottery system. The account identifier is authenticated at a host computer and the authentication of the account identifier is transmitted to the lottery system. A cost associated with one or more lottery picks for a lottery transaction is also received from a lottery system. The host computer determines the cost does not exceed an account balance associated with the account identifier and an authorization for the lottery transaction is transmitted to the lottery system. In some instances, the method may further include subtracting the cost from the account balance.

According to one embodiment, the method may further include receiving information on a reload amount at the host computer system. For example, the reload amount may be received from a point-of-sale device. The reload amount may be added to the account balance. The method may also include creating a settlement report. The settlement report may include an identification of the merchant associated with the point-of-sale device and a monetary amount owed by the merchant. The monetary amount includes the reload amount. Alternately or additionally, the method may comprise initiating an Automated Clearing House (ACH) transaction to transfer a monetary amount (including the reload amount) from the merchant associated with the point-of-sale device to a third party associated with the lottery system.

In another embodiment, a method for authorizing a lottery transaction comprises receiving an account identifier for a stored value lottery card from a lottery system. The account identifier is authenticated at a host computer system. The host computer system also determines an account balance associated with the account identifier and a maximum number of lottery picks available based on the account balance. An authentication of the account identifier and the maximum number of lottery picks available is transmitted to the lottery system.

In some embodiments, a cost associated with one or more lottery picks is received. The host computer system reduces the account balance by the cost of the one or more lottery picks.

In a third embodiment, a method for activating a stored value lottery account is disclosed. The method comprises receiving, at a point-of-sale (POS) device, an account identifier associated with a presentation instrument. A value to be associated with the account identifier is also received at the POS device. The account identifier and the value is transmitted from the POS device to a host computer system. The host computer system determines the account identifier is valid and activates the account identifier. The host computer system then transmits new account information, which includes the account identifier, to a lottery system.

In a fourth embodiment, a system is disclosed. The system comprises a data storage including a plurality of stored value lottery account identifiers, a status associated with each of the stored value lottery account identifiers, and an account balance associated with each of one or more of the stored value lottery account identifiers. The system further includes a communications interface. The communications interface is configured to receive a request to authenticate a stored value lottery account identifier and to transmit an authentication of the stored value lottery account identifier. The communications interface is also configured to receive a cost associated with one or more lottery picks for a lottery transaction and to transmit an authorization for the lottery pick transaction. Additionally, the system comprises a processor to retrieve the status and the account balance associated with the account identifier from the data store and to authenticate the identifier based at least partially on the account status. The processor is further to authorize the lottery transaction based at least in part on a determination that the cost does not exceed the account balance.

### BRIEF DESCRIPTION OF THE DRAWINGS

FIG. 1A is a front view of one embodiment of a presentation instrument that may be used with the invention.

FIG. 1B is a rear view of the presentation instrument of FIG. 1A.

FIG. 2 is a schematic view of a diagram of a point-of-sale device that may be used in accordance with the present invention.

FIG. 3 is a schematic diagram of a system that may be utilized to manage lottery transactions or play various lotteries according to the invention.

FIG. 4 is a flow diagram illustrating one exemplary method for activating a stored value lottery account.

FIG. 5 is a flow diagram illustrating an exemplary method for authorizing a lottery transaction.

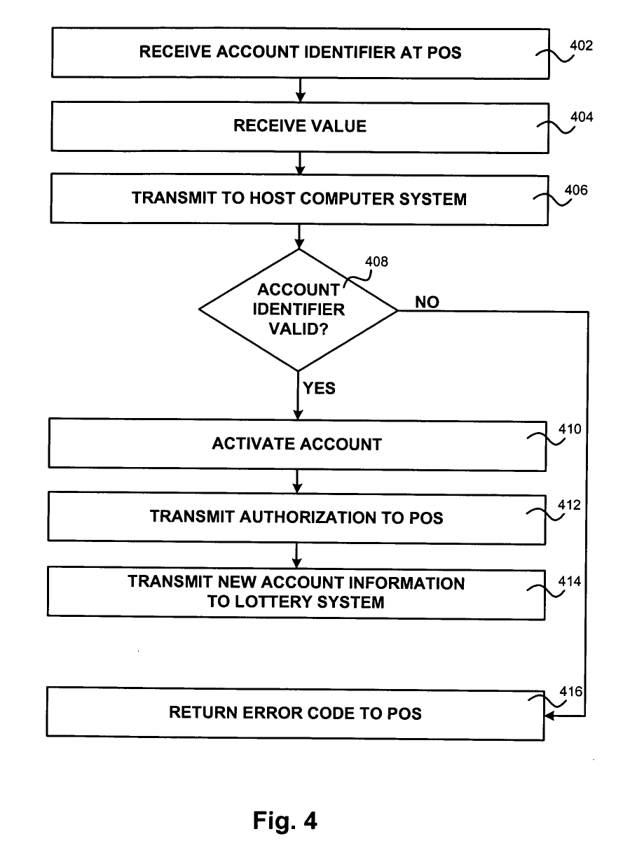

FIGS. 4A and 4B are flow charts illustrating one method for playing a lottery according to the invention.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

In one aspect, the invention provides systems and methods for authorizing lottery transactions and playing various lotteries. Examples of lotteries that may be authorized and/or played using the invention include those offered by most state lottery systems, such as Powerball, Lotto and the like, although the invention is not limited to only these types of lotteries. The invention is particularly suitable for games where a number or other identifier is selected, and a winner is determined by randomly selecting a winning number or identifier. If the player's selection matches some or all of the winning number or identifier, the player is deemed a winner and may claim a prize. Although useful with government sanctioned lotteries, the invention may be used with other types of organizations including charities, social organizations, company raffles and the like.

To facilitate payment, the invention may utilize stored value accounts. In this way, when a player wishes to play one or more games, the payment may be made by debiting a stored value account. The stored value of an account typically has an associated identifier that may be conveniently be stored on a presentation instrument, such as a card. Such presentation instruments may initially be in an inactive state where no value is associated with the presentation instrument. To associate a value with the account, a consumer may purchase one of the cards for a certain amount, such as fifty dollars. Conveniently, this transaction (referred to as an activation) may be processed at a merchant or retail location. In such cases, the merchant collects a payment, using cash, credit card, debit card or any other acceptable form of payment, and enters this information into a point-of-sale device. The account identifier associated with the presentation instrument is also entered into the point-of-sale device. For example, the identifier may be stored on a magnetic stripe, on a bar code label, or the like. Examples of such point-of-sale devices that may be used to capture and/or transmit such information to a host computer system are described in copending U.S. application Ser. No. 10/116,619, filed Apr. 3, 2002, the complete disclosure which is herein incorporated by reference. However, it will be appreciated that the invention is not intended to be limited to a specific type of processing/reading device. For example, other ways of transmitting information include by telephone (such as by using an IVR system), mobile or wireless devices, by contacting a customer service representative or the like. Reload transactions, where value is added to an existing account, may occur in a similar manner.

Such information is transmitted to the host computer system which has a record of the account identifier. Such information may be transmitted across a variety of networks including telephone networks, credit card networks, wide area networks, the Internet, wireless networks, and the like. Further, depending on the type of processing device used to transmit the information, such devices may also be coupled to a financial network, such as a credit card or ATM network, or may have a direct connection to the host computer system. If connected to a financial network, the host computer system may be configured to determine that the transaction is related to a stored value account rather than a traditional credit or debit card and may process the information appropriately.

When such information is received at the host computer system, the value that was paid by the consumer is associated with the account identifier. In so doing, the account is activated so that the consumer may then use the presentation instrument for playing a lottery. In some cases, the stored value may be used in other applications as well. For example, the stored value account may be used for making purchases. For instance, a stored value transaction may ride the financial rails of so-called gift card transactions currently processed by ValueLink of First Data Corporation. In this way, a presentation instrument that is used to play lottery games may also be used to make purchases. In a similar manner, if a player wins a lottery, the winnings may be credited to the same stored value account and used to make subsequent purchases.

To play a lottery (or to redeem part or all of the value associated with the presentation instrument (sometimes referred to as a redemption transaction)), the consumer simply needs to provide the account identifier at the time a ticket is to be purchased or a redemption transaction is to be performed. For example, if a consumer desired to play a lottery game, the player may simply provide the presentation instrument to the clerk at a retail location, using an IVR system or the like. If provided at a retail location, the identifier may be read from the presentation instrument using a point-of-sale device and transmitted back to the host computer system. Along with this information, the game that the player wishes to play may also be transmitted. This may be entered and transmitted using the point of sale device, or using any of the techniques previously described. The host computer system is configured to determine the amount of value remaining in the account and to debit the account by the cost of the game. Information confirming the transaction may be transmitted back to the point-of-sale device. Such information may include a lottery pick selected by the player or randomly generated by the host computer system, the point of sale device, or the like. In some cases, such as with scratch and win games, the player may be issued a ticket having regions that may be scratched off in order to play a game.

Other information regarding the transaction that may be transmitted back to the point-of-sale device includes the amount debited, the new balance, the date of play, rules of the game, and the like. Some or all of this information may be displayed by the point-of-sale device and may optionally be printed to provide a paper receipt.

Consumers or players may perform transactions, such as redemptions, activations, reloads, requests to play and the like at merchant locations, such as at retail stores, using the Internet or from some other type of network, including the phone network. If needed, a ticket or confirmation may be printed showing the purchase, requests to play, lottery picks and the like. If at a point of sale location, an associated printer may be used to print this information. Similarly, if at a personal computer (such as when accessing the system using the Internet), an associated printer may be used. In cases where a game is played using a IVR system, the player could go to a web site, a point of sale location or the like to print the confirmation.

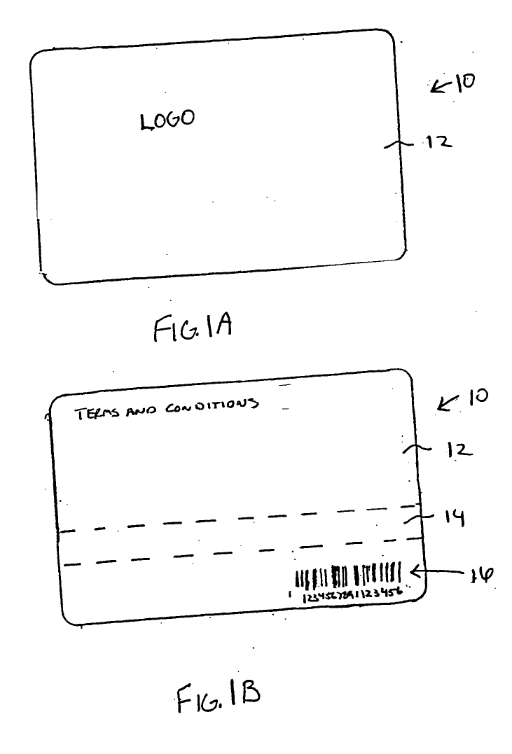

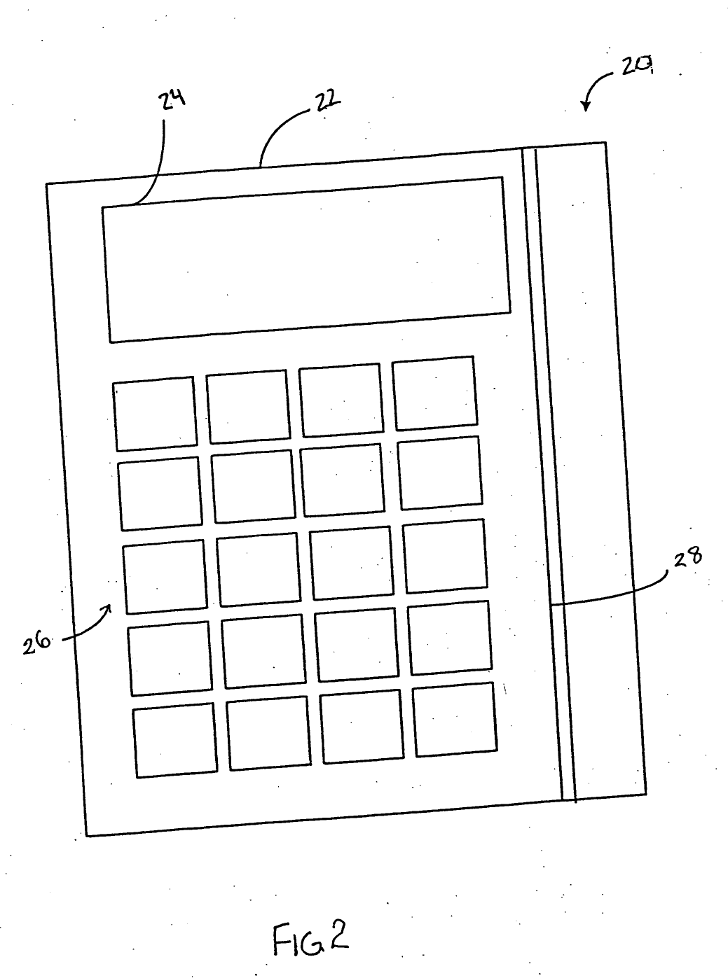

Referring now to FIGS. 1A and 1B, one embodiment of a presentation instrument 10 that may be used with the invention will be described. In general, the presentation instruments of the invention may be constructed of a wide variety of materials that are capable of storing an identifier that uniquely identifies the associated account. For example, the material may comprise a card 12 (that in turn may be constructed of plastic, cardstock, paper, or the like). Other materials include a computer disk (such as a CD, DVD or the like) or other tangible media. Further, the identifier may be stored in a variety of formats, such as in print, on magnetic media (such as a magnetic stripe 14), in a bar code format 16, in a computer processor (also known as a smart chip) or the like. Appropriate readers may be employed at the point-of-sale to read such formats and then transmit them to the host computer system for processing. Card 12 may also include lottery identification information, such as a name, logo, or the like.

Referring now to FIG. 2, a point-of-sale device 20 that may be used will be described in greater detail. In so doing, it will be appreciated that the invention is not intended to be limited for use with only a specific type of point-of-sale device. Indeed, any type of processing or computing device that may transmit and receive data over a network may be used.

Point-of-sale device 20 comprises a housing 22 having a display screen 24 and input devices 26. Conveniently, input device 26 may comprise keys or buttons that may be depressed to enter information into a point-of-sale device 14. Input devices 26 may each be associated with one or more letters or other alpha numeric characters, or may operate as function keys.

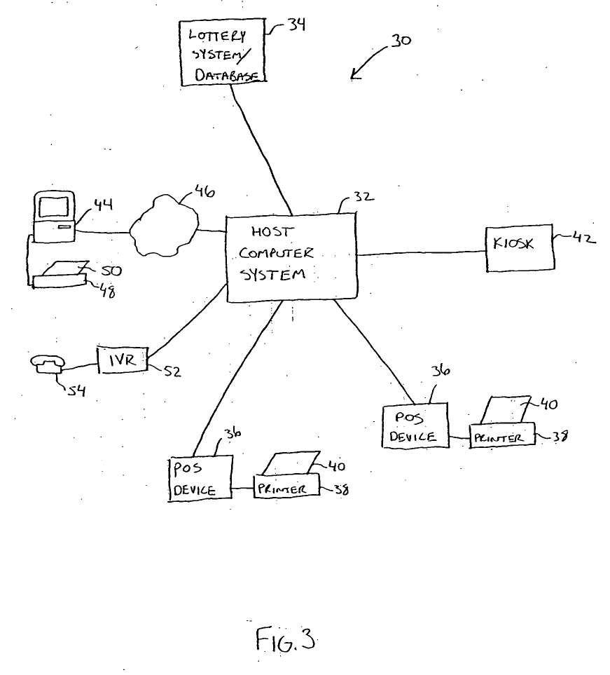

Referring now to FIG. 3, one embodiment of a lottery management system will be described. Lottery management system 30 comprises a host computer system 32 that is used to store a wide variety of information relating to stored value accounts as well as to facilitate management of such accounts and management of various aspects of a lottery. One of the functions of host computer system 32 is to maintain account identifiers for each of the accounts and an associated account balance value, if available, and/or an associated status (e.g., active, inactive, closed). This information may be stored in a data storage (e.g., relational database, spreadsheet, text file) communicatively coupled with the host computer system. As accounts are activated, credited and/or debited, host computer system 32 is employed to perform these functions in a manner similar to that described herein, as well as in co-pending U.S. Application No. 60/392,958, filed Jun. 28, 2002, U.S. application Ser. No. 10/268,040, filed Oct. 8, 2002, U.S. application Ser. No. 10/267,180, filed Oct. 8, 2002, U.S. application Ser. No. 10/286,006, filed Nov. 1, 2002, U.S. application Ser. No. 10/356,207, filed Jan. 30, 2003, U.S. application Ser. No. 10/371,167, filed Feb. 21, 2003, the complete disclosures of which are herein incorporated by reference. As such, host computer system 32 may include appropriate hardware, software and databases for these functions as is known in the art. Host computer system 32 may also include one or more communications interface for receiving and transmitting information in electronic form. For example, information may be received from point-of-sale devices, voice response units, server computers, personal computers, wireless devices and the like. Similarly, outputs may be transmitted to any device capable of receiving electronic documents. Additionally, host computer system 32 may include one or more processors to perform the functions described. It should be appreciated that host computer system 32 may be implemented on more than one physical machine.

In some cases, the account identifiers may be provided to host computer system 32 from a lottery database 34 or other type of computer system. In this way, a government entity overseeing the lottery can select and transmit the account identifiers to host computer system 32. Alternatively, host computer system 32 may generate its own account identifiers. The account identifiers may also be provided to a production facility to store the account identifiers on presentation instruments.

Lottery database 34 may also be used to provide winning numbers to host computer system 32 so that winners may be determined as described herein. Alternatively, winning numbers could be generated directly at host computer system 32.

System 30 may utilize a variety of devices to associate a value with an account identifier so that a game may be paid for and played. For example, a traditional point of sale device 36 may be configured to communicate with host computer system 30. To activate an account, the identifier from the presentation instrument may be entered into point of sale device 36 and transmitted to host computer system 32 which checks to make sure the identifier is valid. If so, the amount of value that is to be associated with the account identifier is entered into point of sale device 36 and transmitted to host computer system 32. This value is stored in a database along with the account identifier. If value is to be added to an existing account, it may be done in the same way. Optionally, a printer 38 may be used to produce a receipt 40 giving the details of the transaction.

As another example, presentation instruments may be purchased from and/or activated at a kiosk 42. One example of such a kiosk is described in copending U.S. application Ser. No. 10/225,410, filed Aug. 20, 2002, the complete disclosure of which is herein incorporated by reference. Using kiosk 42, the account identifier and payment amount may be transmitted to host computer system 32 in a manner similar to that described with point of sale devices 36. Also, kiosk 42 may print a receipt as well.

Another device for adding value to an account is using a personal computer 44 that communicates with host computer system 32 using a network 46, such as the Internet. Computer 44 may comprise essentially any type of computing device capable of transmitting data and may include an interface, such as a web browser, to facilitate entry and display of information. Using computer 44, information on the account identifier as well as a payment instrument, such as a credit card, debit card, stored value card, bank account, or the like, may be entered and transmitted to host computer system 32 where it is saved. A printer 48 may be used to print a receipt 50 containing the details of the transaction.

As a further example, an account identifier and payment information may be transmitted to an interactive voice response (IVR) system 52 using a phone 54. In some cases, IVR system 52 could be substituted with a live operator, such as a customer service representative, who enters the information into a computer (similar to computer 44). The IVR system may be used to obtain lottery picks from a customer associated with an account identifier. In some embodiments, host computer system 32 may communicate with IVR system 52 to provide authentication and authorization for lottery transactions. The IVR system 52 may then communicate lottery picks to lottery system 34. Alternately, as will be described below, the lottery picks may be communicated to host computer system 32.

In some embodiments, host computer system 32 may be used to play various lotteries. In these embodiments, to play a game, host computer system 32 may be accessed using any of the devices described herein. Depending on the game that is played, the player transmits certain information to host 32. For example, for a traditional lottery, the player enters the account identifier where the host computer system 32 checks to see if enough value is associated with the account to play the game. If so, the player may also transmit a lottery pick. The player may select his own pick or request that the system generate a quick pick. The player may also select a date at which the lottery is to be played. This information is then stored at the host computer system 32 until the lottery is played. The account may also be debited by the amount required to play the lottery. In order to receive confirmation of the lottery pick and the payment amount, a receipt may be printed using any of the printers. In cases where a pick is selected but no printer is available (such as by using a phone), the player may access another device, such as POS device 36, which can read the identifier and then cause a ticket to be printed based on the previous pick.

Once a lottery is played, the winning number may be stored in host computer system 32. This number may be compared with all of the other played numbers to determine any potential winners. This information may also be stored at host computer system 32 and could also be transmitted to lottery database 34. If a winning player desires, any winnings may be credited to their stored value account and used to play other lotteries or to make other purchases using their stored value account.

FIG. 4 illustrates an exemplary method for activating a stored value lottery account. The method may begin by receiving 402 an account identifier at a point-of-sale (POS) device. By way of example, the account identifier may be received by swiping a presentation instrument through a magnetic reader and reading the account number magnetically encoded on the presentation instrument. In order to enhance security, the human readable account number may not be simply repeated on the magnetic stripe, but may instead employ an algorithm to break the number up and place it in several different locations on the magnetic stripe. As an additional security measure, the account number may include a checksum. By way of example, the account number may comprise a four digit serial number followed by a four digit checksum derived at by applying an algorithm to the preceding four digits. This may assist in the prevention of unauthorized creation of stored value lottery accounts. As will be described in further detail below, the checksum may be used to validate the received 402 account identifier.

A value to associate with the account identifier may also be received 404 at the POS device. For instances, the amount may be entered into the POS device by a clerk using a keypad or other input mechanism. The account identifier and the value are then transmitted 406 to a host computer system.

The host computer system may then attempt to validate 408 the account identifier. For instance, the host computer system may apply an algorithm to a first portion of the account identifier and validating the result matches a checksum portion of the account identifier. Other techniques may also be used to validate an account. By validating 408 the account, unauthorized activation of accounts may be prevented, or at least inhibited.

If the account identifier is not valid, an error code may be returned to the POS device. Otherwise, if the account identifier is valid, the host computer system may activate 410 the account. In one embodiment, the activation may include changing a status in a data storage to active. The host computer system may also change an account balance associated with the account identifier to reflect the activation value amount.

The method may include transmitting 412 an authorization code for the activation may to the POS device. Additionally, new account information, including the newly activated account identifier and possibly the account balance, may be transmitted 414 to the lottery system. By way of example, the new account information may be transmitted to an Interactive Voice Response (IVR) system and/or a server (e.g., a web server) that may be used to receive lottery picks from a customer associated with the account identifier. The new account information may be transmitted 414 after activation of each new account or at predetermined intervals for accounts that have been activated since the previous interval. Alternately, in some embodiments, the new account information may not be transmitted 414 to the lottery system, but instead the lottery system may use the host computer system to authenticate account identifiers.

In some embodiments, the customer may be able to reload the account. In these embodiments, the customer may be able to reload or add value to the account by making a payment at a merchant, retail location, Internet site, or other physical or virtual location that may be used to receive a payment. The reload amount, along with the account identifier to be reloaded, may then be transmitted to the host computer system. Upon validation of the account identifier, the host computer system may then add the reload amount to an account balance associated with the account identifier. Alternately or additionally, the reload amount may be transmitted to the lottery system. Thus, in some embodiments, the host computer system may not maintain a record of the account balance.

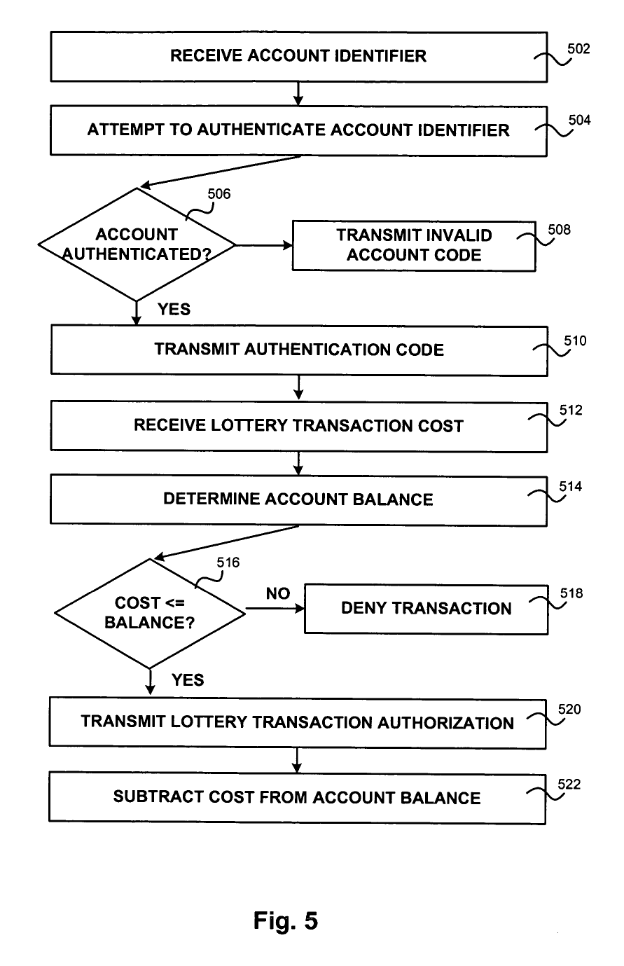

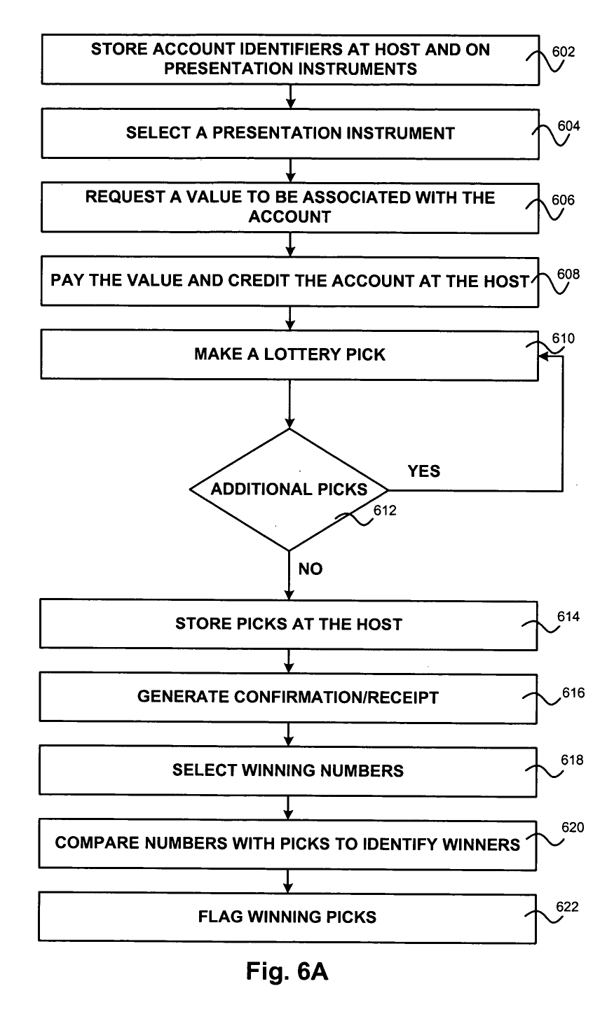

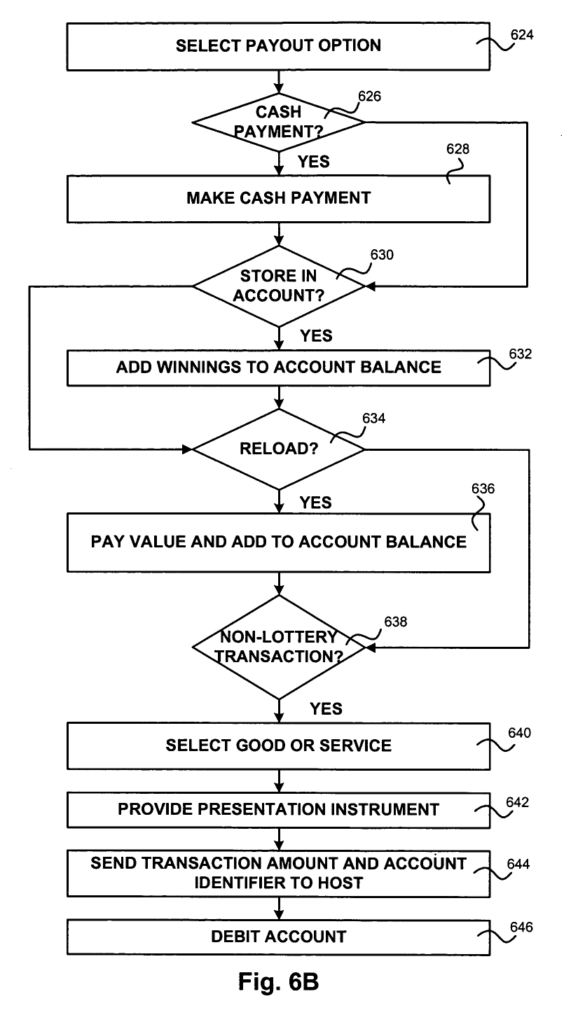

FIG. 5 illustrates an exemplary method that may be used to authorize a lottery transaction. The method may begin by receiving 502 an account identifier at a host computer system, that may have been transmitted from a lottery system, such as an IVR system or web server. An attempt is made to authenticate 504 the account. One or more checks may be done to authenticate 504 the account. For example, the authentication of an account may include validating a checksum portion of the account identifier. As another example, the authentication may include validating a status associated with the account identifier is an active or otherwise valid status. As a third example, the received 502 account identifier may include an account number and a personal identification number and thus, the authentication may include the received PIN is associated with the account number. If the account cannot be authenticated 506, a code indicating the account identifier is invalid may be transmitted 508 to the lottery system. Otherwise, if the account is authenticated 506, a code indicating the authentication is transmitted 510 to the lottery system.

The host computer system may then receive 512, from the lottery system, a lottery transaction cost for one or more lottery picks made by the customer associated with the account identifier. The host computer system may then determine 514 the account balance associated with the account identifier, such as by retrieving a record of the account balance from a data storage. If 516 the cost of the transaction is greater than the balance, the host computer system may transmit 518 a code indicating the transaction is denied for insufficient funds. If the account balance does have sufficient funds for the transaction, an authorization for the lottery transaction may be transmitted to the lottery system. The host computer system may also subtract 522 the cost of the transaction from the record of the account balance.

In an alternate embodiment, the lottery system may manage the verification of funds. Thus, if the host computer system is managing the record of the account balance, the host computer system may transmit the account balance to the lottery system after receiving 502 the account identifier. Alternately, the host computer system may determine a maximum number of lottery picks that a customer may make with the associated balance and may transmit the maximum allowed picks to the lottery system. After the lottery system has received one or more lottery picks, the lottery system may transmit the cost of the lottery picks and the host computer system may then reduce the associated account balance accordingly.

In some embodiments, the host computer system may also facilitate settlement between merchants selling or reloading stored value lottery accounts and the lottery system. Thus, the host computer system may create settlement reports that indicate merchant identifiers and the amount the merchants owe the lottery system. Optionally, the host computer system may also perform settlement functions. By way of example, the host computer system may initiate Automated Clearing House (ACH) transactions between the merchant and the lottery system to transfer amounts owed by the merchant to the lottery system.

Referring now to FIGS. 6A and 6B, a method for opening an account and playing a lottery will be described. As shown in step 602, account identifiers are stored at a host computer and on presentation instruments. When ready to open an account, a person selects a presentation instrument as shown in step 604. The person also selects a value that is to be associated with the account as shown in step 606. The person pays for the value using cash, check, a debit card, a stored value card, a bank account or the like. This value is transmitted to the host and the associated account is credited as shown in step 608.

While making the purchase transaction, or at a subsequent time, a person may make a lottery pick as shown in step 610. The lottery pick may be made by the person who purchased the card or by another person. For instance, the presentation instrument may be purchased as a gift for someone else.

In step 612, the player may choose to make additional picks. If additional picks are made, the process goes back to step 610. For each pick that is selected, the host checks to make sure enough value is in the account and debits the account accordingly. If there is insufficient value, the player is notified and given the opportunity to pay for the play. Each time a pick is made, it is stored at the host as shown in step 614. A confirmation or receipt is also generated as shown in step 616. The receipt may include information such as the player's pick, any rules, the amount paid, the date when the lottery is to be played, the date and time of the pick, and the like. In some cases, this information could also be stored on the presentation instrument.

At an appointed time, a winning number is selected as shown in step 618. This may be done separate from the host computer and then supplied to the host, or even could be done by the host computer. The host computer may also be used to compare the winning number with the picks to determine any winners as shown in step 620. These may be flagged at the host computer as shown in step 622.

If a player is a winner, the player may select a variety of payout options as shown in step 624. For each option, the winner may provide the receipt (or in some cases the presentation instrument) as proof of being a winner. For example, a winner may select a cash payment as shown in step 626. If a cash payment is selected, the winner selects the payout in cash as shown in step 628. This may be received, for example, at a retail location having a point of sale device and a cash register. For larger payments, the winner may be required to pick up the funds as a check or other negotiable instrument.

As another payout option, the winner may receive the winnings in an account as shown in step 630. For instance, the winnings may be added to the winner's stored value account as shown in step 632. This account may be the same one used to pay for the lottery pick, another stored value account, a bank account, or the like. This account may be credited using the host computer directly, through an ACH or ATM transaction, or the like.

At any time an account holder may wish to add value to an account as shown in step 82. This may be accomplished by providing the account identifier to the host computer along with a payment amount as shown in step 634. The host computer may add 636 this to the account balance.

The stored value account may also be used for non-lottery transactions as well as shown in step 638. For example, the stored value may be used to purchase goods or services as shown in step 640. After making a selection, the presentation instrument may be provided at the point of sale as shown in step 642. Alternatively, the account identifier could be provided, such as when making an Internet purchase or mail order purchase. The account identifier is transmitted to the host computer (step 644) where the account is debited (step 646).

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware, firmware, and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method for authorizing a lottery transaction, the method comprising:
receiving, from a lottery system, an account identifier for a stored value lottery account;
authenticating, at a host computer system, the account identifier;
transmitting, to the lottery system, an authentication of the account identifier;
receiving, from the lottery system, a cost associated with one or more lottery picks for a lottery transaction;
determining, at the host computer system, the cost does not exceed an account balance associated with the account identifier; and
transmitting, to the lottery system, an authorization for the lottery transaction.

2. The method of claim 1, further comprising subtracting the cost from the account balance.

3. The method of claim 1, wherein authenticating the account identifier includes validating the account is active.

4. The method of claim 1, wherein receiving an account identifier comprises receiving an account number and a personal identification number.

5. The method of claim 4, wherein authenticating the account identifier comprises determining the personal identification number is associated with the account number.

6. The method of claim 1, wherein receiving the account identifier from a lottery system comprises receiving the account identifier from an interactive voice response (IVR) system operative to receive lottery picks from a customer associated with the account identifier.

7. The method of claim 1, further comprising:
receiving, at the host computer system, information on a reload amount; and
adding the reload amount to the account balance.

8. The method of claim 7, wherein receiving the reload amount comprises receiving the reload amount from a point-of-sale device.

9. The method of claim 8, further comprising at the host computer system, creating a settlement report, the settlement report including an identification of the merchant associated with the point-of-sale device and a monetary amount owed by the merchant, the monetary amount including the reload amount.

10. The method of claim 8, further comprising at the host computer system, initiating an Automated Clearing House (ACH) transaction to transfer a monetary amount from the merchant associated with the point-of-sale device, to a third party associated with the lottery system, the monetary amount including the reload amount.

11. A method for authorizing a lottery transaction, the method comprising:
receiving, from a lottery system, an account identifier for a stored value lottery card;
authenticating, at a host computer system, the account identifier;
determining, at the host computer system, an account balance associated with the account identifier;
determining a maximum number of lottery picks available based on the account balance; and
transmitting, to the lottery system, an authentication of the account identifier and the maximum number of lottery picks available.

12. The method of claim 11, further comprising:
receiving, from the lottery system, a cost associated with one or more lottery picks; and
reducing, at the host computer system, the account balance by the cost of the one or more lottery picks.

13. A method for activating a stored value lottery account, the method comprising:
receiving, at a point-of-sale (POS) device, an account identifier associated with a presentation instrument;
receiving a value, at the POS device, to associate with the account identifier;
transmitting, from the POS device, the account identifier and the value to a host computer system;
determining, at the host computer system, the account identifier is valid;
activating, at the host computer system, the account identifier; and
transmitting, from the host computer system, new account information to a lottery system, the new account information including the account identifier.

14. The method of claim 13, further comprising transmitting, from the host computer system, an authorization code to the POS device.

15. The method of claim 13, wherein transmitting new account information to a lottery system comprises transmitting the new account information to an interactive voice response (IVR) system operative to receive lottery picks from a customer associated with the account identifier.

16. The method of claim 13, wherein the account identifier includes an account number and a checksum and wherein determining the account identifier is valid comprises applying an algorithm to the account number to produce a result and validating the result matches the checksum.

17. The method of claim 13, further comprising:
receiving, at the host computer system, a reload amount associated with the account identifier; and
transmitting the reload amount to the lottery system.

18. A system comprising:
a data storage, the data storage including a plurality of stored value lottery account identifiers, a status associated with each of the stored value lottery account identifiers, and an account balance associated with each of one or more of the stored value lottery account identifiers;
a communications interface to receive a request to authenticate a stored value lottery account identifier, to transmit an authentication of the stored value lottery account identifier, to receive a cost associated with one or more lottery picks for a lottery transaction, and to transmit an authorization for the lottery pick transaction; and
a processor to retrieve the status and the account balance associated with the account identifier from the data store; to authenticate the identifier based at least partially on the account status; and to authorize the lottery transaction based at least in part on a determination the cost does not exceed the account balance.

19. The system of claim 18, wherein the processor is further configured to reduce the account balance by the cost.

20. The system of claim 18, wherein the communications interface is further to receive a reload amount and the processor is further configured to increase the account balance by the reload amount.

21. The system of claim 20, further comprising a point-of-sale (POS) device, communicatively coupled with the communications interface, the POS device to transmit the reload amount to the communications interface.

22. The system of claim 18, wherein the communications interface is further configured to receive a second stored value lottery account identifier; and
wherein the processor is further configured to authenticate the second stored value lottery account identifier and to alter the status in the data storage associated with the second stored value lottery account identifier to an active status.
